(19) United States
(12) Patent Application Publication
(10) Pub. No.: US 2019/0040915 A1
(43) Pub. Date: Feb. 7, 2019

(54) DAMPER DEVICE

(71) Applicant: AISIN AW CO., LTD., Anjo-shi, Aichi-ken (JP)

(72) Inventors: Kazuyoshi ITO, Tsushima (JP); Masaki WAJIMA, Nagoya (JP); Hiroki NAGAI, Anjo (JP)

(73) Assignee: AISIN AW CO., LTD., Anjo-shi, Aichi-ken (JP)

(21) Appl. No.: 16/076,527

(22) PCT Filed: Mar. 16, 2017
(86) PCT No.: PCT/JP2017/010632

§ 371 Date: Aug. 8, 2018

(30) Foreign Application Priority Data
Mar. 16, 2016 (JP) 2016-052685

(51) Int. Cl. F16D 3/12; F16F 15/134

(52) U.S. Cl. CPC F16D 3/12; F16H 45/02; F16F 15/134; F16F 15/13469

(57) ABSTRACT

A damper device that includes an input to which torque from an engine is transmitted; an output; a first intermediate element; a second intermediate element; a first transmission member that transmits torque between the input and the first intermediate element; a second transmission member that transmits torque between the first intermediate element and the output; a third transmission member that transmits torque between the input and the second intermediate element; a fourth transmission member that transmits torque between the second intermediate element and the output; and a fifth transmission member that transmits torque between the first intermediate element and the second intermediate element, wherein at least one of the first, second, third, fourth, and fifth transmission members has variable stiffness that tends to increase as a rotation speed of the damper device increases.

### BACKGROUND

The present disclosure relates to a damper device having an input element to which torque from an engine is transmitted and an output element.

As this type of damper device, a double-path damper that is used in conjunction with a torque converter has been hitherto known (e.g., see JP 2012-506006 A). In this damper device, a vibration path from an engine and a lock-up clutch to an output hub is divided into two parallel vibration paths B, C, and the two vibration paths B, C each have a pair of springs and a separate intermediate flange that is disposed between the pair of springs. A turbine of the torque converter is coupled to the intermediate flange of the vibration path B in order to differentiate the natural frequencies of these two vibration paths, and the natural frequency of the intermediate flange of the vibration path B is lower than the natural frequency of the intermediate flange of the vibration path C. In such a damper device, when the lock-up clutch is engaged, vibration from the engine propagates into the two vibration paths B, C of the damper device. When engine vibration of a certain frequency reaches the vibration path B including the intermediate flange coupled to the turbine, the phase of the vibration from the intermediate flange of the vibration path B to the output hub shifts 180 degrees relative to the phase of the input vibration. Since the natural frequency of the intermediate flange of the vibration path C is higher than the natural frequency of the intermediate flange of the vibration path B, the vibration having propagated into the vibration path C is transmitted to the output hub without undergoing a phase shift. Thus causing a 180-degree shift between the phase of the vibration transmitted through the vibration path B to the output hub and the phase of the vibration transmitted through the vibration path C to the output hub can damp vibration in the output hub.

### SUMMARY

In the above damper device, when the rotation speed (vibration frequency) of the damper device (engine) increases to exceed a rotation speed corresponding to the natural frequency of the vibration path B, the phase of the vibration transmitted through the vibration path B to the output hub and the phase of the vibration transmitted through the vibration path C to the output hub become opposite from each other, resulting in reduced vibration in the output hub. The vibration in the output hub is sufficiently reduced (minimized) when the rotation speed of the damper device reaches a certain rotation speed. When the rotation speed of the damper device further increases, the vibration in the output hub increases, despite the opposite phases of the vibration transmitted through the vibration path B to the output hub and the vibration transmitted through the vibration path C to the output hub, as the difference in amplitude between these vibrations increases. Thus, the range of rotation speed in which this damper device can deliver good vibration damping performance is relatively narrow.

An exemplary aspect of the disclosure provides a damper device having an input element to which torque from an engine is transmitted, and an output element, wherein the range of rotation speed in which the damper device can deliver good vibration damping performance is expanded.

A first damper device of the present disclosure is a damper device that includes an input to which torque from an engine is transmitted; and output; a first intermediate element; a second intermediate element; a first transmission member that transmits torque between the input and the first intermediate element; a second transmission member that transmits torque between the first intermediate element and the output; a third transmission member that transmits torque between the input and the second intermediate element; a fourth transmission member that transmits torque between the second intermediate element and the output; and a fifth transmission member that transmits torque between the first intermediate element and the second intermediate element. At least one of the first, second, third, fourth, and fifth transmission members has variable stiffness that tends to increase as the rotation speed of the damper device increases.

In the first damper device of the present disclosure, two natural frequencies can be set for the device as a whole. Thus, when resonance occurs at a lower natural frequency of the two natural frequencies as the rotation speed of the damper device increases, one of vibration transmitted from the second transmission member to the output and vibration transmitted from the fourth transmission member to the output cancels out at least part of the other, resulting in reduced vibration in the output. The vibration in the output is sufficiently reduced when the rotation speed of the damper device reaches a certain rotation speed. Moreover, in this damper device, at least one of the first, second, third, fourth, and fifth transmission members has variable stiffness that tends to increase as the rotation speed of the damper device increases. This allows the state where the vibration in the output is sufficiently small to continue (to follow) when the rotation speed of the damper device increases beyond a certain rotation speed. As a result, the range of rotation speed in which the damper device can deliver good vibration damping performance can be expanded.

A second damper device of the present disclosure is a damper device that includes an input to which torque from an engine is transmitted; and output; a first torque transmission path having a first intermediate element, a first transmission member that transmits torque between the input and the first intermediate element, and a second transmission member that transmits torque between the first intermediate element and the output; and a second torque transmission path having a second intermediate element, a third transmission member that transmits torque between the input and the second intermediate element, and a fourth transmission member that transmits torque between the second intermediate element and the output, the second torque transmission path being provided parallel to the first torque transmission path. At least one of the first, second, third, and fourth transmission members has variable stiffness that tends to increase as the rotation speed of the damper device increases.

In the second damper device of the present disclosure, two natural frequencies can be set for the device as a whole, as in the first damper device described above. Thus, when resonance occurs at a lower natural frequency of the two natural frequencies as the rotation speed of the damper device increases, one of vibration transmitted from the second transmission member to the output and vibration transmitted from the fourth transmission member to the output cancels out at least part of the other, resulting in reduced vibration in the output. The vibration in the output is sufficiently reduced when the rotation speed of the damper device reaches a certain rotation speed. Moreover, in this damper device, at least one of the first, second, third, and fourth transmission members has variable stiffness that tends to increase as the rotation speed of the damper device increases. This allows the state where the vibration in the output is sufficiently small to continue (to follow) when the rotation speed of the damper device increases beyond a certain rotation speed. As a result, the range of rotation speed in which the damper device can deliver good vibration damping performance can be expanded.

A third damper device of the present disclosure is a damper device that includes an input to which torque from an engine is transmitted; and output; a first torque transmission path having an intermediate element, a first transmission member that transmits torque between the input and the intermediate element, and a second transmission member that transmits torque between the intermediate element and the output; and a second torque transmission path having a third transmission member that transmits torque between the input and the output, the second torque transmission path being provided parallel to the first torque transmission path. At least one of the first, second, and third transmission members has variable stiffness that tends to increase as the rotation speed of the damper device increases.

In the third damper device of the present disclosure, when resonance occurs at the natural frequency of the damper device as a whole as the rotation speed of the damper device increases, one of vibration transmitted from the second transmission member to the output and vibration transmitted from the third transmission member to the output cancels out at least part of the other, resulting in reduced vibration in the output. The vibration in the output is sufficiently reduced when the rotation speed of the damper device reaches a certain rotation speed. Moreover, in this damper device, at least one of the first, second, and third transmission members has variable stiffness that tends to increase as the rotation speed of the damper device increases. This allows the state where the vibration in the output is sufficiently small to continue (to follow) when the rotation speed of the damper device increases beyond a certain rotation speed. As a result, the range of rotation speed in which the damper device can deliver good vibration damping performance can be expanded.

A fourth damper device of the present disclosure is a damper device that includes an input to which torque from an engine is transmitted; and output; a torque transmission path having an intermediate element, a first transmission member that transmits torque between the input and the intermediate element, and a second transmission member that transmits torque between the intermediate element and the output; and a rotary inertia mass damper having a mass body that rotates in response to a relative rotation between the input and the output, the rotary inertia mass damper being provided between the input and the output so as to be parallel to the torque transmission path. At least one of the first and second transmission members has variable stiffness that tends to increase as the rotation speed of the damper device increases.

In the fourth damper device of the present disclosure, the phase of vibration transmitted from the input to the output through the torque transmission path and the phase of vibration transmitted from the input to the output through the rotary inertia mass damper become opposite from each other. When resonance occurs at the natural frequency of the torque transmission path (intermediate element) as the rotation speed of the damper device increases, vibration in the output is reduced, and the vibration in the output is sufficiently reduced when the rotation speed of the damper device reaches a certain rotation speed. Moreover, in this damper device, at least one of the first and second transmission members has variable stiffness that tends to increase as the rotation speed of the damper device increases. This allows the state where the vibration in the output is sufficiently small to continue (to follow) when the rotation speed of the damper device increases beyond a certain rotation speed. As a result, the range of rotation speed in which the damper device can deliver good vibration damping performance can be expanded.

### BRIEF DESCRIPTION OF THE DRAWINGS

FIG. 1 is a schematic configuration diagram showing a starter including a damper device of the present disclosure.

FIG. 2 is a schematic view showing a main part of the damper device of the present disclosure.

FIG. 3 is an enlarged schematic view of a portion of the main part of the damper device.

FIG. 4 is a view illustrating the damper device in operation.

FIG. 5 is a graph schematically illustrating a relationship between the rotation speed of the damper device and a vibration amplitude (torque vibration) in a driven member of the damper device of an embodiment of the present disclosure and in a driven member of a damper device of a comparative embodiment.

FIG. 6 is a graph illustrating characteristics, relative to a synthetic spring constant, of two natural frequencies and an anti-resonance frequency.

FIG. 7 is a schematic configuration diagram showing a starter including another damper device of the present disclosure.

FIG. 8 is a schematic configuration diagram showing a starter including another damper device of the present disclosure.

FIG. 9 is a schematic configuration diagram showing a starter including another damper device of the present disclosure.

FIG. 10 is a schematic configuration diagram showing a starter including another damper device of the present disclosure.

FIG. 11 is a schematic configuration diagram showing a starter including another damper device of the present disclosure.

### DETAILED DESCRIPTION OF EMBODIMENTS

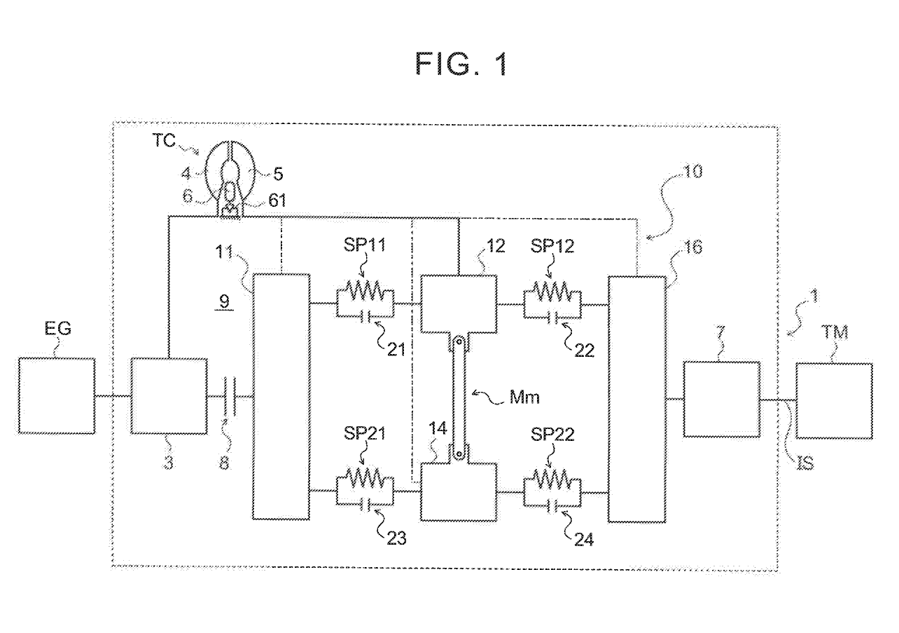

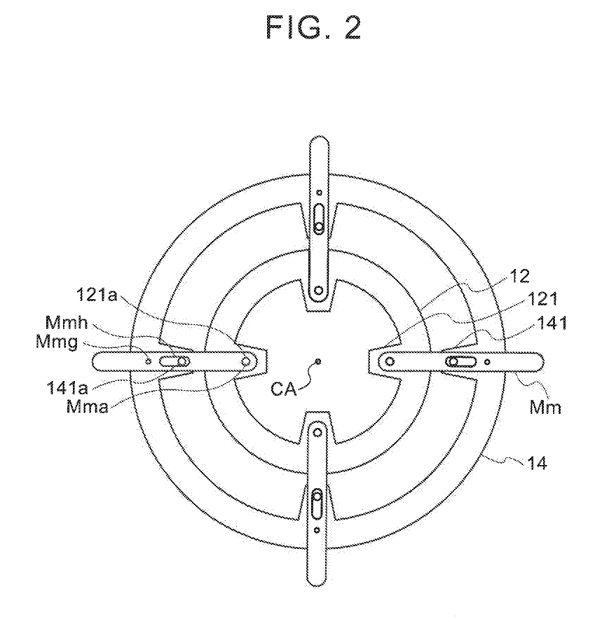

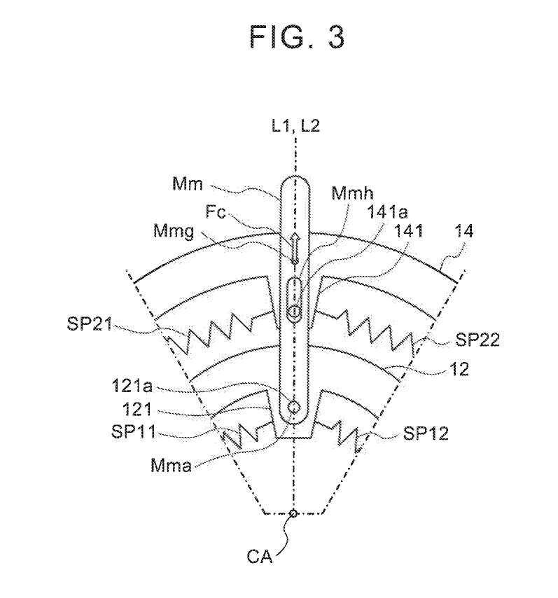

Next, an embodiment of the present disclosure will be described. FIG. 1 is a schematic configuration diagram showing a starter 1 including a damper device 10 of the present disclosure. FIG. 2 is a schematic view showing a main part of the damper device 10 of the present disclosure. FIG. 3 is an enlarged schematic view of a portion of the main part of the damper device 10. In FIG. 3, first to fourth springs SP11, SP12, SP21, SP22 are also shown.

The starter 1 shown in FIG. 1 is installed in a vehicle equipped with an engine (in this embodiment, an internal combustion engine) EG serving as a motor, and includes, other than the damper device 10: a front cover 3 coupled to a crankshaft of the engine EG; a torque converter (hydraulic transmission device) TC mounted on the front cover 3; a damper hub 7 serving as a power output member that is coupled to the damper device 10 and fixed to an input shaft IS of a transmission (power transmission device) TM that is an automatic transmission (AT), a continuously variable transmission (CVT), a dual-clutch transmission (DCT), a hybrid transmission, or a reducer; and a lock-up clutch 8. The torque converter TC includes: a pump impeller (input-side hydraulic transmission element) 4 fixed to the front cover 3; a turbine runner (output-side hydraulic transmission element) 5 that can rotate coaxially with the pump impeller 4 and is, in the present disclosure, fixed to a first intermediate member 12 to be described later; a stator 6 that regulates the flow of a hydraulic fluid (working fluid) from the turbine runner 5 to the pump impeller 4; and a one-way clutch 61 that regulates the rotation direction of the stator 6. The lock-up clutch 8 performs a lock-up operation to couple the front cover 3 to the damper hub 7 via the damper device 10 and an operation to release the lock-up.

In the following description, unless otherwise specified, an “axial direction” basically refers to an extension direction of a central axis CA (axis; see FIG. 2 and FIG. 3) of the starter 1 and the damper device 10. Unless otherwise specified, a “radial direction” basically refers to a radial direction of a rotary element such as the damper device 10, i.e., an extension direction of a straight line extending from the central axis CA in a direction orthogonal to the central axis CA (in the direction of the radius). Moreover, unless otherwise specified, a “circumferential direction” basically refers to a circumferential direction of a rotary element such as the damper device 10, i.e., a direction along a rotation direction of that rotary element.

The damper device 10 is provided between the engine EG and the transmission TM to damp vibration, and as shown in FIG. 1, has a drive member (input element) 11, a first intermediate member (first intermediate element) 12, a second intermediate member (second intermediate element) 14, and a driven member (output element) 16 as rotary elements (rotary members, i.e., rotary mass bodies) that coaxially rotate relative to one another. The damper device 10 further includes, as torque transmission elements (torque transmission members): a plurality of (in this embodiment, for example, four) first springs (first transmission members) SP11 as elastic bodies that are disposed between the drive member 11 and the first intermediate member 12 to transmit rotational torque (torque in the rotation direction); a plurality of (in this embodiment, for example, four) second springs (second transmission members) SP12 as elastic bodies that are disposed between the first intermediate member 12 and the driven member 16 to transmit rotational torque (torque in the rotation direction); a plurality of (in this embodiment, for example, four) third springs (third transmission members) SP21 as elastic bodies that are disposed between the drive member 11 and the second intermediate member 14 to transmit rotational torque; a plurality of (in this embodiment, for example, four) fourth springs (fourth transmission members) SP22 as elastic bodies that are disposed between the second intermediate member 14 and the driven member 16 to transmit rotational torque; and a plurality of (in this embodiment, for example, four) intermediate transmission members (fifth transmission members) Mm that are disposed between the first intermediate member 12 and the second intermediate member 14 to transmit rotational torque.

In this embodiment, the first to fourth springs SP11, SP12, SP21, SP22 may be linear coil springs each made of a metal material and wound into a spiral shape so as to have an axis extending straight under no load. Each of the first to fourth springs SP11, SP12, SP21, SP22 has constant stiffness (spring constant). Alternatively, at least one of the first to fourth springs SP11 to SP22 may be an arc coil spring.

In this embodiment, the first and second springs SP11, SP12 are installed at a radially inner region inside a hydraulic transmission chamber 9 so as to be arrayed alternately along the circumferential direction of the damper device 10 (first intermediate member 12), with corresponding ones of the first springs SP11 and the second springs SP12 forming a pair (acting in series). The third and fourth springs SP21, SP22 are installed radially outward of the first and second springs SP11, SP12 so as to be arrayed alternately along the circumferential direction of the damper device 10 (second intermediate member 14), with corresponding ones of the third springs SP21 and the fourth springs SP22 forming a pair (acting in series). Moreover, the first to fourth springs SP11, SP12, SP21, SP22 are disposed in the same plane. Thus, the axial length of the damper device 10 can be reduced.

The drive member 11 is fixed to a lock-up piston, a clutch drum, or a clutch hub of the lock-up clutch 8. Thus, as the lock-up clutch 8 is engaged, the front cover 3 (engine EG) and the drive member 11 of the damper device 10 are coupled to each other. Although not shown, the drive member 11 has a plurality of (in this embodiment, for example, four) inner spring contact portions that are formed at intervals (regular intervals) in the circumferential direction, and a plurality of (in this embodiment, for example, four) outer spring contact portions that are formed at intervals in the circumferential direction, at positions radially outward of the plurality of inner spring contact portions.

As shown in FIG. 2 and FIG. 3, the first intermediate member 12 is an annular member, and has a plurality of (in this embodiment, for example, four) spring contact portions 121 that are formed at intervals (regular intervals) in the circumferential direction so as to each protrude radially inward. As shown in FIG. 2 and FIG. 3, the second intermediate member 14 is an annular member having a larger diameter than the first intermediate member 12, and has a plurality of (in this embodiment, for example, four) spring contact portions 141 that are formed at intervals (regular intervals) in the circumferential direction so as to each protrude radially inward.

The driven member 16 is fixed to the damper hub 7. Although not shown, the driven member 16 has a plurality of (in this embodiment, for example, four) inner spring contact portions (elastic body spring contact portions) that are formed at intervals in the circumferential direction, at positions close to an inner circumferential edge of the driven member 16, and a plurality of (in this embodiment, for example, four) outer spring contact portions (elastic body spring contact portions) that are formed at intervals in the circumferential direction, at positions radially outward of the plurality of inner spring contact portions.

In a mounted state of the damper device 10 (a static state where the damper device 10 has been assembled and is not operating), each inner spring contact portion of the drive member 11 is located between the first and second springs SP11, SP12 that do not make a pair (do not act in series), and is in contact with ends of these springs. Similarly, in the mounted state of the damper device 10, each inner spring contact portion of the driven member 16 is located between the first and second springs SP11, SP12 that do not make a pair (do not act in series), and is in contact with ends of these springs. Moreover, in the mounted state of the damper device 10, each outer spring contact portion of the drive member 11 is located between the third and fourth springs SP21, SP22 that do not make a pair (do not act in series), and is in contact with ends of these springs. Similarly, in the mounted state of the damper device 10, each outer spring contact portion of the driven member 16 is located between the third and fourth springs SP21, SP22 that do not make a pair (do not act in series), and is in contact with ends of these springs.

Each spring contact portion 121 of the first intermediate member 12 is located between the first and second springs SP11, SP12 that make a pair, and is in contact with ends of these springs. Each spring contact portion 141 of the second intermediate member 14 is located between the third and fourth springs SP21, SP22 that make a pair, and is in contact with ends of these springs.

Thus, in the mounted state of the damper device 10, one end of each first spring SP11 is in contact with the corresponding inner spring contact portion of the drive member 11 and the corresponding inner spring contact portion of the driven member 16, while the other end of each first spring SP11 is in contact with the corresponding spring contact portion 121 of the first intermediate member 12. In the mounted state of the damper device 10, one end of each second spring SP12 is in contact with the corresponding spring contact portion 121 of the first intermediate member 12, while the other end of each second spring SP12 is in contact with the corresponding inner spring contact portion of the drive member 11 and the corresponding inner spring contact portion of the driven member 16.

Moreover, one end of each third spring SP21 is in contact with the corresponding outer spring contact portion of the drive member 11 and the corresponding outer spring contact portion of the driven member 16, while the other end of each third spring SP21 is in contact with the corresponding spring contact portion 141 of the second intermediate member 14. In the mounted state of the damper device 10, one end of each fourth spring SP22 is in contact with the corresponding spring contact portion 141 of the second intermediate member 14, while the other end of each fourth spring SP22 is in contact with the corresponding outer spring contact portion of the drive member 11 and the corresponding outer spring contact portion of the driven member 16.

As a result, the driven member 16 is coupled to the drive member 11 through the plurality of first springs SP11, the first intermediate member 12, and the plurality of second springs SP12, and is coupled to the drive member 11 through the plurality of first springs SP21, the second intermediate member 14, and the plurality of second springs SP22.

As shown in FIG. 2, the plurality of intermediate transmission members Mm are coupled to the first intermediate member 12 and the second intermediate member 14 so as to be 90 degrees apart from one another (in a radial manner). As shown in FIG. 2 and FIG. 3, each intermediate transmission member Mm is formed so as to have substantially constant width and thickness and extend in a constant direction, and a hole Mmh extending along an extension direction of the intermediate transmission member Mm is formed at a center part of the intermediate transmission member Mm. Each intermediate transmission member Mm is supported by a pin 121a formed at the spring contact portion 121 of the first intermediate member 12, so as to be able to pivot. A pin 141a formed at the spring contact portion 141 of the second intermediate member 14 is located inside the hole Mmh of each intermediate transmission member Mm. Thus, each intermediate transmission member Mm is supported by the pin 141a so as to be able to pivot and move in an extension direction of the hole Mmh. In the mounted state of the damper device 10 (a state where the first intermediate member 12 and the second intermediate member 14 are not rotating relative to each other), each intermediate transmission member Mm extends in the radial direction. Each intermediate transmission member Mm is formed so as to have a center of gravity Mmg radially outward of a supported point Mma at which the intermediate transmission member Mm is supported by the pin 121a of the first intermediate member 12 so as to be able to pivot.

The damper device 10 has the following two torque transmission paths that do not pass through the intermediate transmission member Mm: a first torque transmission path through which torque is transmitted from the drive member 11 to the driven member 16 through the first spring SP11, the first intermediate member 12, and the second spring SP12; and a second torque transmission path through which torque is transmitted from the drive member 11 to the driven member 16 through the third spring SP21, the second intermediate member 14, and the fourth spring SP22. Moreover, the damper device 10 has the following two torque transmission paths that pass through the intermediate transmission member Mm: a third torque transmission path through which torque is transmitted from the drive member 11 to the driven member 16 through the first spring SP11, the first intermediate member 12, the intermediate transmission member Mm, the second intermediate member 14, and the fourth spring SP22; and a fourth torque transmission path through which torque is transmitted from the drive member 11 to the driven member 16 through the third spring SP21, the second intermediate member 14, the intermediate transmission member Mm, the first intermediate member 12, and the second spring SP12. Furthermore, the damper device 10 as a whole (in this embodiment, the first and second intermediate members 12, 14, the first to fourth springs SP11, SP12, SP21, SP22, and the intermediate transmission members Mm) has two natural frequencies.

As shown in FIG. 1, the damper device 10 further includes: a first stopper 21 that restricts relative rotation between the drive member 11 and the first intermediate member 12 and deflection of the first spring SP11; a second stopper 22 that restricts relative rotation between the first intermediate member 12 and the driven member 16 and deflection of the second spring SPI2; a third stopper 23 that restricts relative rotation between the drive member 11 and the second intermediate member 14 and deflection of the third spring SP21; and a fourth stopper 24 that restricts relative rotation between the second intermediate member 14 and the driven member 16 and deflection of the fourth spring SP22.

Next, operations of the damper device 10 will be described. In the damper device 10, when the lock-up clutch 8 of the starter 1 is engaged (fully engaged or slip-engaged), rotational torque (input torque) transmitted from the engine EG to the drive member 11 through the front cover 3 and the lock-up clutch 8 is transmitted to the driven member 16 and the damper hub 7, basically through the above-described first to fourth torque transmission paths. When the lock-up clutch 8 is fully engaged, the rotation speed of the engine EG and the rotation speed of the damper device 10 (drive member 11, etc.) are equal to each other, and an excitation frequency of the engine EG and the frequency of vibration transmitted from the engine EG to the damper device 10 (drive member 11, etc.) are equal to each other. On the other hand, when the lock-up clutch 8 is slip-engaged, the rotation speed of the engine EG and the rotation speed of the damper device 10 are different from each other, and the excitation frequency of the engine EG and the frequency of vibration transmitted from the engine EG to the damper device 10 are different from each other. For simplicity's sake, the following description is based on the assumption that the lock-up clutch 8 is fully engaged.

Here, as shown in FIG. 3, since the intermediate transmission member Mm extends in the radial direction when the relative torsional angle between the first intermediate member 12 and the second intermediate member 14 is zero, a straight line L1 passing through the central axis CA of the damper device 10 and the pin 141a of the second intermediate member 14, and a straight line L2 extending in the extension direction of the intermediate transmission member Mm (a straight line passing through the pin 121a of the first intermediate member 12 and the pin 141a of the second intermediate member 14), coincide with each other. In this case, a centrifugal force Fc according to the rotation speed of the damper device 10 (the rotation speed of the intermediate transmission member Mm) acts on the intermediate transmission member Mm. When the mass of the intermediate transmission member Mm is m, the distance from the central axis CA of the damper device 10 to the center of gravity Mmg of the intermediate transmission member Mm is Rg, and the rotation speed of the intermediate transmission member Mm is N, the centrifugal force Fc can be expressed by the following Formula (1):

Fc=m·N²·Rg (1)

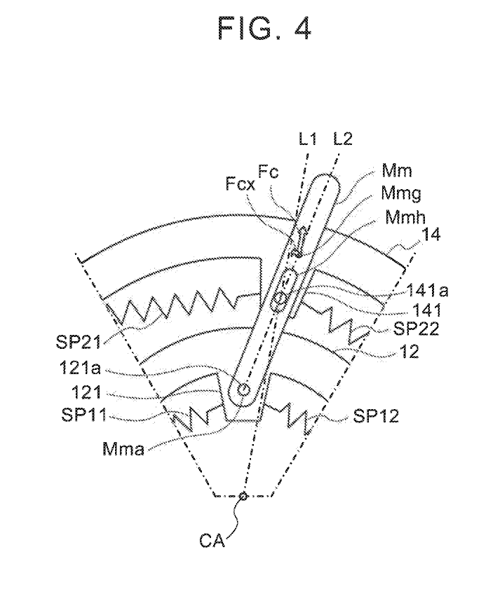

As shown in FIG. 4, when the relative torsional angle between the first intermediate member 12 and the second intermediate member 14 changes from zero, the straight line L1 and the straight line L2 are misaligned, and a component force Fcx of the centrifugal force Fc acting in the direction of reducing the relative torsional angle between the first rotary member 12 and the second intermediate member 14 (a force acting in a direction that is orthogonal to the straight line L2 and counterclockwise in FIG. 4) occurs according to the angle of misalignment between the straight line L1 and the straight line L2. Then, a force according to the component force Fcx is exerted by the intermediate transmission member Mm onto the second intermediate member 14. Here, the force exerted by the intermediate transmission member Mm onto the second intermediate member 14 is proportional to the relative torsional angle between the first intermediate member 12 and the second intermediate member 14. Therefore, the intermediate transmission member Mm can be considered as an equivalent of an elastic body. Since the centrifugal force Fc acting on the intermediate transmission member Mm is proportional to the square of the rotation speed of the damper device 10 (the rotation speed of the intermediate transmission member Mm), the force exerted by the intermediate transmission member Mm onto the second intermediate member 14 is proportional to the square of the rotation speed of the damper device 10 (the rotation speed of the intermediate transmission member Mm). Thus, it can be said that the stiffness of the intermediate transmission member Mm (the spring constant of the intermediate transmission member Mm when the intermediate transmission member Mm is considered as an equivalent of an elastic body, i.e., the torsional stiffness of the rotary body) increases as the rotation speed of the damper device 10 (the rotation speed of the intermediate transmission member Mm) increases. Moreover, setting the center of gravity Mmg of the intermediate transmission member Mm further outward in the radial direction can increase the force exerted by the intermediate transmission member Mm onto the second intermediate member 14.

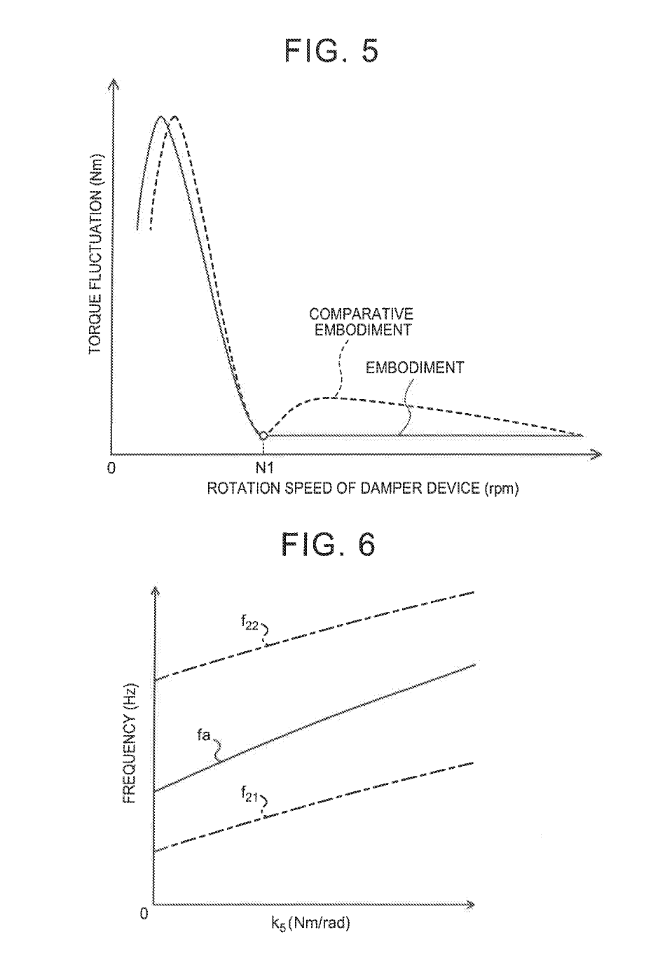

FIG. 5 is a graph schematically illustrating a relationship between the rotation speed of the damper device 10 and a vibration amplitude (torque fluctuation) in the driven member of the damper device 10 of the embodiment and in a driven member of a damper device of a comparative embodiment. In FIG. 5, the solid line represents the case of the damper device 10 of the embodiment, and the dashed line represents the case of the damper device of the comparative embodiment. A damper device that does not have the intermediate transmission member Mm of the damper device 10 is considered here as the comparative embodiment.

As described above, the damper device 10 as a whole (in this embodiment, the first and second intermediate members 12, 14, the first to fourth springs SP11, SP12, SP21, SP22, and the intermediate transmission members Mm) has two natural frequencies. Thus, when resonance occurs at a lower natural frequency of the two natural frequencies as the rotation speed of the damper device 10 (the frequency of vibration input into the damper device 10) increases, the phase of vibration transmitted from the second spring SP12 to the driven member 16 and the phase of vibration transmitted from the fourth spring SP22 to the driven member 16 shift from each other. Therefore, as indicated by the present disclosure (solid line) and the comparative embodiment (dashed line) in FIG. 5, when resonance occurs at the lower natural frequency of the two natural frequencies as the rotation speed of the damper device 10 (the rotation speed of the intermediate transmission member Mm) increases, one of the vibration transmitted from the second spring SP12 to the driven member 16 and the vibration transmitted from the fourth spring SP22 to the driven member 16 cancels out at least part of the other, resulting in reduced vibration in the driven member 16. The vibration in the driven member 16 is sufficiently small (minimized, in the case of the comparative embodiment) when the rotation speed of the damper device 10 reaches a certain rotation speed N1. Hereinafter, the rotation speed (frequency) of the damper device 10 at which the vibration in the driven member 16 is sufficiently small (minimized, in the case of the comparative embodiment) will be referred to as an anti-resonance rotation speed (frequency). Under ideal conditions, this anti-resonance rotation speed means the rotation speed (frequency) of the damper device 10 at which torque vibrations of the second and fourth springs SP12, SP22 connected to the driven member 16 are equal in amplitude and opposite in phase, and as a result, the torque fluctuation in the driven member 16 becomes zero.

Through various analyses, the present inventors have found that an anti-resonance frequency fa in the damper device 10 including the first to fourth springs SP11, SP12, SP21, SP22 and the intermediate transmission members Mm can be obtained by Formula (2). The symbols in Formula (2) denote as follows: J21 is an inertial moment of the first intermediate member 12; J22 is an inertial moment of the second intermediate member 14; k1 is a synthetic spring constant (stiffness) of the plurality of first springs SP11 acting in parallel between the drive member 11 and the first intermediate member 12; k2 is a synthetic spring constant (stiffness) of the plurality of second springs SP12 acting in parallel between the first intermediate member 12 and the driven member 16; k3 is a synthetic spring constant (stiffness) of the plurality of third springs SP21 acting in parallel between the drive member 11 and the second intermediate member 14; k4 is a synthetic spring constant (stiffness) of the plurality of fourth springs SP22 acting in parallel between the second intermediate member 14 and the driven member 16; and k5 is a synthetic spring constant (stiffness) of the plurality of intermediate transmission members Mm acting in parallel between the first intermediate member 12 and the second intermediate member 14, when the intermediate transmission members Mm are considered as equivalents of elastic bodies. The present inventors have also found that, when the synthetic spring constants k1, k2, k3, k4 and the inertial moments J21, J22 are constant values and the synthetic spring constant k5 is a variable, the characteristics, relative to the synthetic spring constant k5, of the anti-resonance frequency fa and the lower natural frequency f21 and the higher natural frequency f22 of the two natural frequencies of the damper device 10 as a whole can be obtained as shown in FIG. 6. As can be seen from FIG. 6, the natural frequency f21, the anti-resonance frequency fa, and the natural frequency f22 are placed in this order from a lower frequency to a larger frequency, and all these frequencies increase as the synthetic spring constant k5 increases.

$$fa = \frac{1}{2 π} \sqrt{\frac{{k}_{5} \cdot ( {k}_{1} + {k}_{3} ) \cdot ( {k}_{2} + {k}_{4} ) + {k}_{1} {k}_{2} {k}_{3} + {k}_{1} {k}_{2} {k}_{4} + {k}_{1} {k}_{3} {k}_{4} + {k}_{2} {k}_{3} {k}_{4}}{{J}_{21} {k}_{3} {k}_{4} + {J}_{22} {k}_{1} {k}_{2}}} \qquad ( 2 )$$

Again, FIG. 5 will be described. In the comparative embodiment, once the rotation speed of the damper device 10 exceeds the rotation speed N1, the rotation speed increases so as to depart from the anti-resonance rotation speed (the rotation speed corresponding to the frequency fa) and approach a rotation speed (higher resonance rotation speed) corresponding to the higher natural frequency (the natural frequency f22 in FIG. 6) of the two natural frequencies of the damper device 10 as a whole, so that the difference between the phase of vibration transmitted from the second spring SP12 to the driven member 16 and the phase of vibration transmitted from the fourth spring SP22 to the driven member 16 becomes smaller, resulting in increased vibration in the driven member 16. In this embodiment, by contrast, as the rotation speed of the damper device 10 (the rotation speed of the intermediate transmission member Mm) increases, the stiffness of the intermediate transmission member Mm (the synthetic spring constant k5 in Formula (2)) increases and the anti-resonance frequency fa increases accordingly, as can be seen from Formula (2) and FIG. 6. Thus, as the rotation speed of the damper device 10 increases beyond the rotation speed N1, the anti-resonance rotation speed (the rotation speed corresponding to the frequency fa) and the higher resonance rotation speed can be moved toward the higher side (the rotation speed of the damper device 10 can be kept from departing from the anti-resonance rotation speed and from approaching the higher resonance rotation speed). As a result, the range of rotation speed in which the damper device 10 can deliver good vibration damping performance can be expanded. In particular, when the intermediate transmission member Mm is designed so as to vary in the synthetic spring constant k5 in such a manner that the rotation speed of the damper device 10 in each time becomes equal to the anti-resonance rotation speed (the rotation speed corresponding to the frequency fa), the vibration in the driven member 16 becomes nearly equal to the vibration at the rotation speed N1 in the comparative embodiment of FIG. 5 according to the rotation speed of the damper device 10 in each time. As a result, the range of rotation speed in which the damper device 10 can deliver good vibration damping performance can be further expanded.

Thus, in the damper device 10, the two natural frequencies can be set for the device as a whole. When resonance occurs at the lower natural frequency of the two natural frequencies as the rotation speed of the damper device 10 increases, one of vibration transmitted from the second spring SP12 to the driven member 16 and vibration transmitted from the fourth spring SP22 to the driven member 16 cancels out at least part of the other, resulting in reduced vibration in the driven member 16. The vibration in the driven member 16 is sufficiently small when the rotation speed of the damper device 10 is a certain rotation speed. Moreover, in the damper device 10, the intermediate transmission member Mm has variable stiffness that tends to increase as the rotation speed of the damper device 10 (the rotation speed of the intermediate transmission member Mm) increases. This allows the state where the vibration in the driven member 16 is sufficiently small to continue (to follow) when the rotation speed of the damper device 10 increases beyond a certain rotation speed. As a result, the range of rotation speed in which the damper device can deliver good vibration damping performance can be expanded.

In the damper device 10 of the embodiment, the intermediate transmission member Mm is formed so as to have substantially constant width and thickness and extend in a constant direction. Alternatively, the intermediate transmission member Mm may be formed such that the width increases or the thickness increases as the intermediate member Mm extends radially outward, or may have a mass body mounted on its radially outer portion. Thus, the center of gravity Mmg of the intermediate transmission member Mm can be set further outward in the radial direction, so that, when the first intermediate member 12 and the second intermediate member 14 rotate relative to each other, a larger force Fcx2 can be exerted by the intermediate transmission member Mm onto the pin 141a of the second intermediate member 14.

In the damper device 10 of the embodiment, the intermediate transmission member Mm is supported by the first intermediate member 12 that is the inner one of the first intermediate member 12 and the second intermediate member 14, so as to be able to pivot, and is supported by the second intermediate member 14 that is the outer one, so as to be able to pivot and move in the extension direction. Alternatively, the intermediate transmission member Mm may be supported by the second intermediate member 14 that is the outer one of the first intermediate member 12 and the second intermediate member 14, so as to be able to pivot, and may be supported by the first intermediate member 12 that is the inner one, so as to be able to pivot and move in the extension direction. In this case, it is preferable that the center of gravity Mmg of the intermediate transmission member Mm be located radially outward of a position at which the intermediate transmission member Mm is supported by the pin 141a of the second intermediate member 14 so as to be able to pivot. The further outward in the radial direction the center of gravity Mmg of the intermediate transmission member Mm is located, the larger the force is that can be exerted by the intermediate transmission member Mm onto the first intermediate member 12 when the relative torsional angle between the first intermediate member 12 and the second intermediate member 14 is no longer zero.

In the damper device 10 of the embodiment, the intermediate transmission member Mm is used as the fifth transmission member. However, the fifth transmission member may be any member that has variable stiffness that tends to increase as the rotation speed of the damper device 10 (the rotation speed of the intermediate transmission member Mm) increases, and may be a member combining an elastic body having constant stiffness and the intermediate transmission member Mm having variable stiffness.

In the damper device 10 of the embodiment, each of the first to fourth springs SP11, SP12, SP21, SP22 as the first to fourth transmission members has constant stiffness, while the intermediate transmission member Mm as the fifth transmission member has variable stiffness that tends to increase as the rotation speed of the damper device 10 increases. Alternatively, the fifth transmission member may have constant stiffness, while one of the first to fourth transmission members may have variable stiffness that tends to increase as the rotation speed of the damper device 10 increases. Moreover, more than one of the first to fifth transmission members may have variable stiffness that tends to increase as the rotation speed of the damper device 10 increases. For example, one of the first to fourth transmission members, and the fifth transmission member may have variable stiffness that tends to increase as the rotation speed of the damper device 10 increases.

In the damper device 10 of the embodiment, both the first intermediate member 12 and the second intermediate member 14 have an annular shape, with the former located on the inner side and the latter located on the outer side. Alternatively, both the first intermediate member 12 and the second intermediate member 14 may have an annular shape, with the former located on the outer side and the latter located on the inner side.

In the damper device 10 of the embodiment, the first intermediate member 12 is coupled to the turbine runner 5 of the torque converter TC so as to rotate integrally, but the present disclosure is not limited to this example. Specifically, as indicated by the two-dot dashed lines in FIG. 1, the drive member 11 or the driven member 16 may be coupled to the turbine runner 5 so as to rotate integrally, or the second intermediate member 14 may be coupled to the turbine runner 5 so as to rotate integrally.

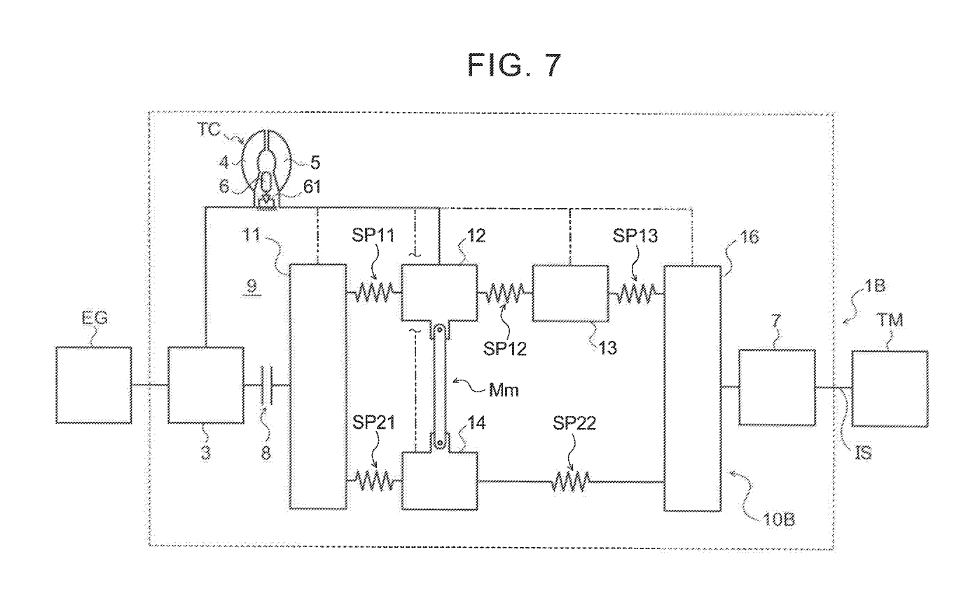

FIG. 7 is a schematic configuration diagram showing a starter 1B including another damper device 10B of the present disclosure. Those components of the damper device 10B that are the same as in the damper device 10 will be denoted by the same reference signs while duplicate description thereof will be omitted.

The damper device 10B shown in FIG. 7 has a third intermediate member (third intermediate element) 13 as a rotary element in addition to the drive member 11, the first and second intermediate members 12, 14, and the driven member 16, and has a fifth spring SP13 as a sixth transmission member and a torque transmission element in addition to the first to fourth springs SP11, SP12, SP21, SP22 and the intermediate transmission members Mm as the first to fifth transmission members. Torque is transmitted from the second spring SP12 to the third intermediate member 13 of the damper device 10B, and the fifth spring SP13 is disposed between the third intermediate member 13 and the driven member 16 to transmit rotational torque therebetween. Thus, the first torque transmission path of the damper device 10B has the first spring SP11, the first intermediate member 12, the second spring SP12, the third intermediate member 13, and the fifth spring SP13. Also in the damper device 10B, the intermediate transmission member Mm has variable stiffness that tends to increase as the rotation speed of the damper device 10 (the rotation speed of the intermediate transmission member Mm) increases.

The damper device 10B can achieve operational effects similar to those of the damper device 10. Moreover, having the fifth spring SP13, the damper device 10B can have lower stiffness, i.e., equivalent stiffness, of the device as a whole, and can thereby achieve further improvement in vibration damping performance.

In the damper device 10B shown in FIG. 7, each of the first to fifth springs SP11, SP12, SP21, SP22, SP13 as the first to fourth and sixth transmission members has constant stiffness, while the intermediate transmission member Mm as the fifth transmission member has variable stiffness that tends to increase as the rotation speed of the damper device 10B increases. Alternatively, the fifth transmission member may have constant stiffness, while one of the first to fourth and sixth transmission members may have variable stiffness that tends to increase as the rotation speed of the damper device 10B increases. Moreover, more than one of the first to sixth transmission members may have variable stiffness that tends to increase as the rotation speed of the damper device 10B increases.

In the damper device 10B shown in FIG. 7, the first intermediate member 12 is coupled to the turbine runner 5 of the torque converter TC so as to rotate integrally, but the present disclosure is not limited to this example. Specifically, as indicated by the two-dot dashed lines in FIG. 7, the drive member 11 or the driven member 16 may be coupled to the turbine runner 5 so as to rotate integrally, or the second intermediate member 14 may be coupled to the turbine runner 5 so as to rotate integrally, or the third intermediate member 13 may be coupled to the turbine runner 5 so as to rotate integrally.

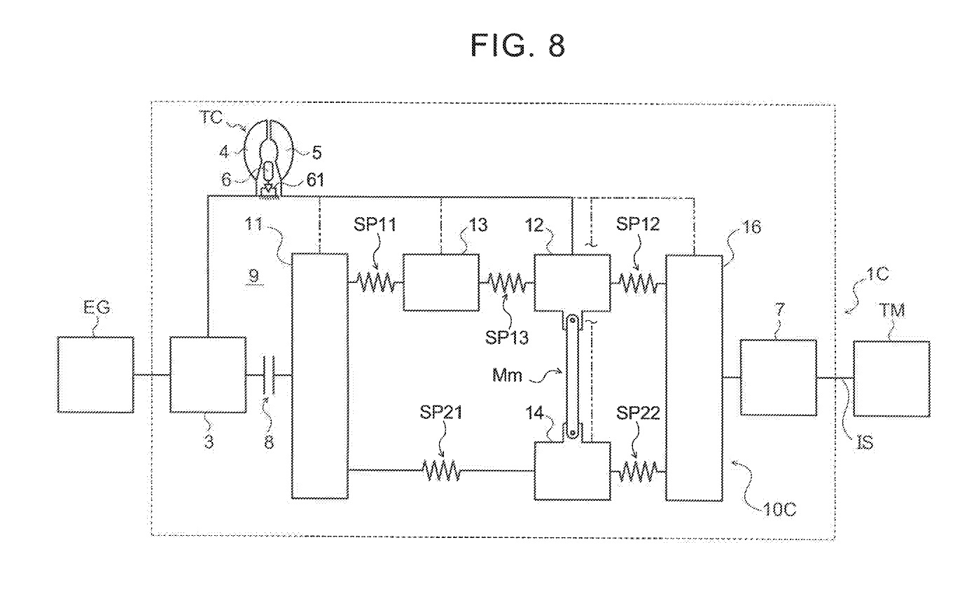

FIG. 8 is a schematic configuration diagram showing a starter IC including another damper device 10C of the present disclosure. Those components of the damper device 10C that are the same as in the damper devices 10, 10B will be denoted by the same reference signs while duplicate description thereof will be omitted.

Like the damper device 10B shown in FIG. 7, the damper device 10C shown in FIG. 8 has the third intermediate member (third intermediate element) 13 as a rotary element in addition to the drive member 11, the first and second intermediate members 12, 14, and the driven member 16, and has the fifth spring SPI3 as a sixth transmission member and a torque transmission element in addition to the first to fourth springs SP11, SP12, SP21, SP22 and the intermediate transmission members Mm as the first to fifth transmission members. Torque is transmitted from the first spring SP11 to the third intermediate member 13 of the damper device 10C, and the fifth spring SP13 is disposed between the third intermediate member 13 and the first intermediate member 12 to transmit rotational torque therebetween. Thus, the first torque transmission path of the damper device 10C has the first spring SP11, the third intermediate member 13, the fifth spring SP13, the first intermediate member 12, and the second spring SP12. In the damper device 10C, each of the first to fifth springs SP11, SP12, SP21, SP22, SP13 has constant stiffness, while the intermediate transmission member Mm has variable stiffness that tends to increase as the rotation speed of the damper device 10C increases. The damper device 10C can achieve operational effects similar to those of the damper device 10B.

In the damper device 10C shown in FIG. 8, each of the first to fifth springs SP11, SP12, SP21, SP22, SP13 as the first to fourth and sixth transmission members has constant stiffness, while the intermediate transmission member Mm as the fifth transmission member has variable stiffness that tends to increase as the rotation speed of the damper device 10C increases. Alternatively, the fifth transmission member may have constant stiffness, while one of the first to fourth and sixth transmission members may have variable stiffness that tends to increase as the rotation speed of the damper device 10C increases. Moreover, more than one of the first to sixth transmission members may have variable stiffness that tends to increase as the rotation speed of the damper device 10C increases.

In the damper device 10C shown in FIG. 8, the first intermediate member 12 is coupled to the turbine runner 5 of the torque converter TC so as to rotate integrally, but the present disclosure is not limited to this example. Specifically, as indicated by the two-dot dashed lines in FIG. 8, the drive member 11 or the driven member 16 may be coupled to the turbine runner 5 so as to rotate integrally, or the second intermediate member 14 may be coupled to the turbine runner 5 so as to rotate integrally, or the third intermediate member 13 may be coupled to the turbine runner 5 so as to rotate integrally.

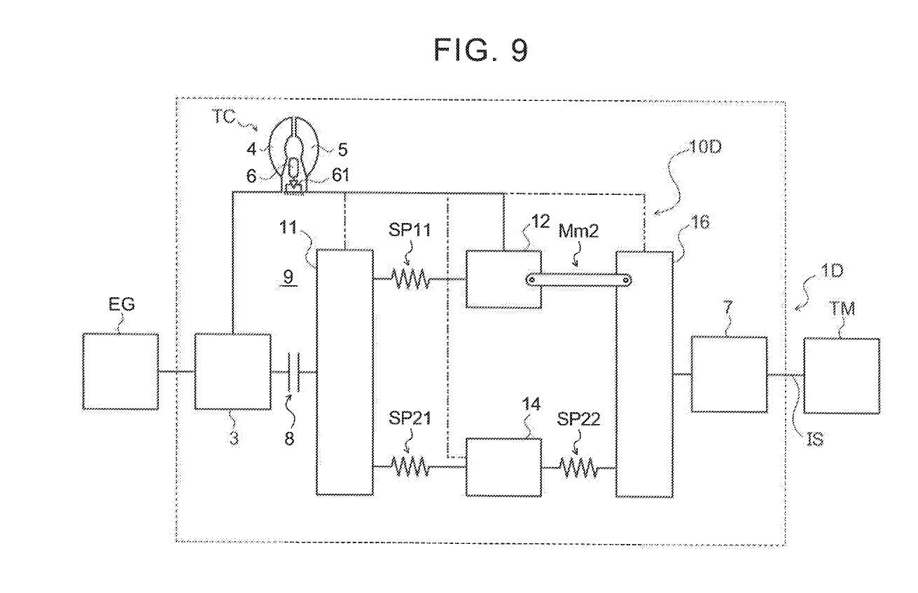

FIG. 9 is a schematic configuration diagram showing a starter 1D including another damper device 10D of the present disclosure. Those components of the damper device 10D that are the same as in the damper device 10 will be denoted by the same reference signs while duplicate description thereof will be omitted.

The damper device 10D shown in FIG. 9 is equivalent to what is obtained by omitting the intermediate transmission member Mm from the damper device 10 of FIG. 1 and replacing the second spring SP12 of the damper device 10 with a transmission member Mm2. Specifically, the damper device 10D has, in addition to the drive member 11, the first and second intermediate members 12, 14, and the driven member 16, the first, third, and fourth springs SP11, SP21, SP22 as the first, third, and fourth transmission members and the transmission member Mm2 as a second transmission member and a torque transmission element. Thus, the first torque transmission path of the damper device 10D has the first spring SP11, the first intermediate member 12, and the transmission member Mm2, while the second torque transmission path has the third spring SP21, the second intermediate member 14, and the fourth spring SP22.

In the damper device 10D, two natural frequencies can be set for the device as a whole, as in the damper device 10. Thus, when resonance occurs at a lower natural frequency of the two natural frequencies as the rotation speed of the damper device 10D increases, one of vibration transmitted from the transmission member Mm2 to the driven member 16 and vibration transmitted from the fourth spring SP22 to the driven member 16 cancels out at least part of the other, resulting in reduced vibration in the driven member 16. The vibration in the driven member 16 is sufficiently small when the rotation speed of the damper device 10D is a certain rotation speed. Moreover, in the damper device 10D, the transmission member Mm2 has variable stiffness that tends to increase as the rotation speed of the damper device 10D (the rotation speed of the transmission member Mm2) increases. This allows the state where the vibration in the driven member 16 is sufficiently small to continue (to follow) when the rotation speed of the damper device 10D increases beyond a certain rotation speed. As a result, the range of rotation speed in which the damper device 10D can deliver good vibration damping performance can be expanded.

In the damper device 10D shown in FIG. 9, each of the first, third, and fourth springs SP11, SP21, SP22 as the first, third, and fourth transmission members has constant stiffness, while the transmission member Mm2 as the second transmission member has variable stiffness that tends to increase as the rotation speed of the damper device 10D increases. Alternatively, the second transmission member may have constant stiffness, while one of the first, third, and fourth transmission members may have variable stiffness that tends to increase as the rotation speed of the damper device 10D increases. Moreover, more than one of the first to fourth transmission members may have variable stiffness that tends to increase as the rotation speed of the damper device 10D increases.

In the damper device 10D shown in FIG. 9, the first intermediate member 12 is coupled to the turbine runner 5 of the torque converter TC so as to rotate integrally, but the present disclosure is not limited to this example. Specifically, as indicated by the two-dot dashed lines in FIG. 9, the drive member 11 or the driven member 16 may be coupled to the turbine runner 5 so as to rotate integrally, or the second intermediate member 14 may be coupled to the turbine runner 5 so as to rotate integrally.

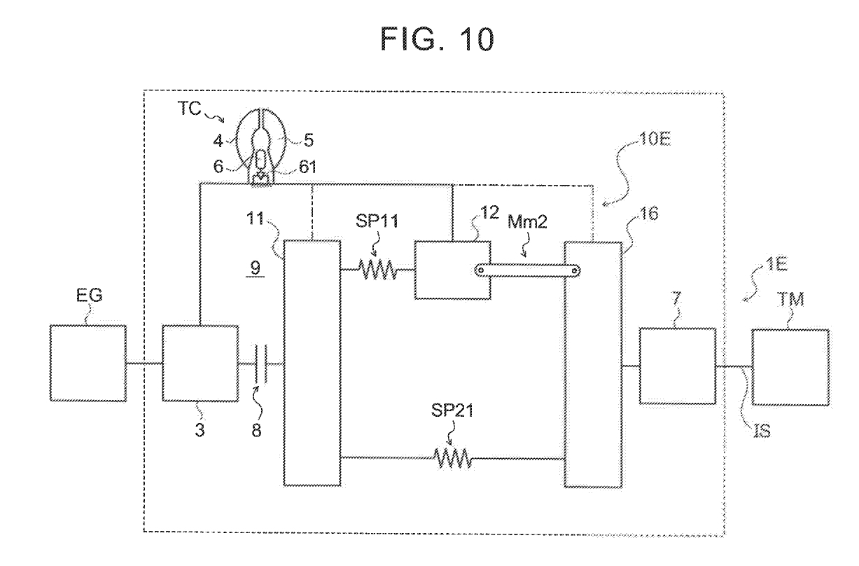

FIG. 10 is a schematic configuration diagram showing a starter 1E including another damper device 10E of the present disclosure. Those components of the damper device 10E that are the same as in the damper device 10 will be denoted by the same reference signs while duplicate description thereof will be omitted.

The damper device 10E shown in FIG. 10 is equivalent to what is obtained by omitting the second intermediate member 14 and the fourth spring SP22 from the damper device 10D of FIG. 9. Specifically, the damper device 10E has, in addition to the drive member 11, the first intermediate member 12, and the driven member 16, the first and third springs SP11, SP21 as the first and third transmission members and the transmission member Mm2 as the second transmission member and a torque transmission element. Thus, the first torque transmission path of the damper device 10E has the first spring SP11, the first intermediate member 12, and the transmission member Mm2, while the second torque transmission path has the third spring SP21.

In the damper device 10E, when resonance occurs at the natural frequency of the damper device 10E as a whole as the rotation speed of the damper device 10E increases, one of vibration transmitted from the transmission member Mm2 to the driven member 16 and vibration transmitted from the third spring SP21 to the driven member 16 cancels out at least part of the other, resulting in reduced vibration in the driven member 16. The vibration in the driven member 16 is sufficiently small when the rotation speed of the damper device 10E is a certain rotation speed. Moreover, in the damper device 10E, the transmission member Mm2 has variable stiffness that tends to increase as the rotation speed of the damper device 10E (the rotation speed of the transmission member Mm2) increases. This allows the state where the vibration in the driven member 16 is sufficiently small to continue (to follow) when the rotation speed of the damper device 10E increases beyond a certain rotation speed. As a result, the range of rotation speed in which the damper device 10E can deliver good vibration damping performance can be expanded.

In the damper device 10E shown in FIG. 10, each of the first and third springs SP11, SP21 as the first and third transmission members has constant stiffness, while the transmission member Mm2 as the second transmission member has variable stiffness that tends to increase as the rotation speed of the damper device 10E increases. Alternatively, the second transmission member may have constant stiffness, while one of the first and third transmission members may have variable stiffness that tends to increase as the rotation speed of the damper device 10E increases. Moreover, more than one of the first to third transmission members may have variable stiffness that tends to increase as the rotation speed of the damper device 10E increases.

In the damper device 10E shown in FIG. 10, the first intermediate member 12 is coupled to the turbine runner 5 of the torque converter TC so as to rotate integrally, but the present disclosure is not limited to this example. Specifically, as indicated by the two-dot dashed lines in FIG. 10, the drive member 11 or the driven member 16 may be coupled to the turbine runner 5 so as to rotate integrally.

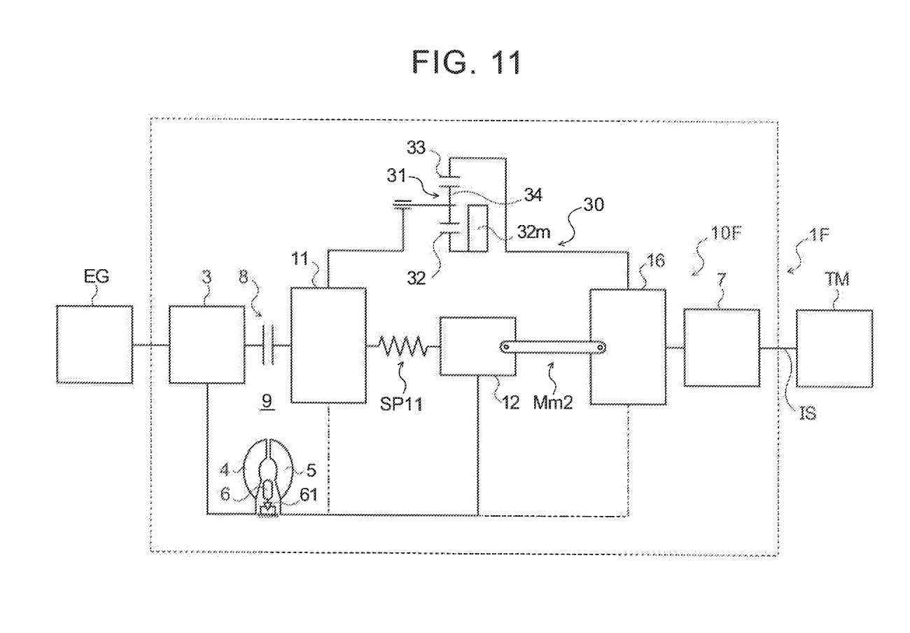

FIG. 11 is a schematic configuration diagram showing a starter 1F including another damper device 10F of the present disclosure. Those components of the damper device 10F that are the same as in the damper device 10 will be denoted by the same reference signs while duplicate description thereof will be omitted.

The damper device 10F shown in FIG. 11 is equivalent to what is obtained by omitting the third spring SP21 from the damper device 10E of FIG. 10 and adding a rotary inertia mass damper 30 to the damper device 10E. Specifically, the damper device 10F has, in addition to the drive member 11, the first intermediate member 12, and the driven member 16, the first spring SP11 as the first transmission member, the transmission member Mm2 as the second transmission member, and the rotary inertia mass damper 30. Thus, the torque transmission path has the first spring SP11, the first intermediate member 12, and the transmission member Mm2.

The rotary inertia mass damper 30 is provided parallel to the torque transmission path (the path having the first spring SP11, the first intermediate member 12, and the transmission member Mm2) relative to the drive member 11 and the driven member 16. The inertia mass damper 30 is formed by a single-pinion planetary gear 31 that is disposed between the drive member 11 and the driven member 16. The planetary gear 31 includes a sun gear 32 that is an external gear, a ring gear 33 that is an internal gear and disposed concentrically with the sun gear 32, and a plurality of (in this embodiment, for example, three) pinion gears 34 that each mesh with the sun gear 32 and the ring gear 33.

The sun gear 32 of the planetary gear 31 has, on an inner side of a plurality of external teeth thereof, a mass part 32m that serves to increase the inertial moment. The ring gear 33 is fixed to the driven member 16. Thus, the ring gear 33 can rotate integrally with the driven member 16. The plurality of pinion gears 34 are arrayed at intervals (regular intervals) in the circumferential direction, and are supported by the lock-up piston of the lock-up clutch 8 so as to be able to rotate. The lock-up piston can rotate integrally with the drive member 11 that is the input element of the damper device 10F. Thus, the lock-up piston functions as a planetary carrier of the planetary gear 31 that supports the plurality of pinion gears 34 so that the pinion gears 34 are able to rotate and revolve relative to the sun gear 32 and the ring gear 33.

In the damper device 10F, when the lock-up by the lock-up clutch 8 of the starter 1F is released, as can be seen from FIG. 11, torque transmitted from the engine EG to the front cover 3 is transmitted to the input shaft IS of the transmission TM through a path having the pump impeller 4, the turbine runner 5, the intermediate member 12, the transmission member Mm2, the driven member 16, and the damper hub 7. By contrast, when the lock-up is performed by the lock-up clutch 8 of the starter 1F, torque transmitted from the engine EG to the drive member 11 through the front cover 3 and the lock-up clutch 8 is transmitted to the driven member 16 and the damper hub 7 through the torque transmission path including the first spring SP11, the intermediate member 12, and the transmission member Mm2, and through the rotary inertia mass damper 30.

When the drive member 11 rotates (undergoes a torsion) relative to the driven member 16 in the locking state (while the lock-up clutch 8 is engaged), the sun gear 32 as a mass body rotates in response to the relative rotation between the drive member 11 and the driven member 16. Specifically, when the drive member 11 rotates relative to the driven member 16, the rotation speed of the lock-up piston (and the drive member 11) as the planetary carrier that is an input element of the planetary gear 21 becomes higher than the rotation speed of the driven member 16 that rotates integrally with the ring gear 33. In this case, therefore, the speed of the sun gear 32 is increased by the action of the planetary gear 31, so that the sun gear 32 rotates at a higher rotation speed than the lock-up piston and the drive member 11. Thus, an inertial moment (inertia) can be applied from the sun gear 32 that is a mass body of the rotary inertia mass damper 30 to the driven member 16 that is the output element of the damper device 10, thereby damping the vibration in the driven member 16.

In the damper device 10F, the phase of vibration transmitted from the drive member 11 to the driven member 16 through the torque transmission path (the path having the first spring SP11, the first intermediate member 12, and the transmission member Mm2) and the phase of vibration transmitted from the drive member 11 to the driven member 16 through the rotary inertia mass damper 30 are opposite from each other. When resonance occurs at the natural frequency of the torque transmission path (first intermediate member 12) as the rotation speed of the damper device 10F increases, vibration in the driven member 16 is reduced, and when the rotation speed of the damper device 10F is a certain rotation speed, the vibration in the driven member 16 is sufficiently small. Moreover, in the damper device 10F, the transmission member Mm2 has variable stiffness that tends to increase as the rotation speed of the damper device 10F (transmission member Mm2) increases. This allows the state where the vibration in the driven member 16 is sufficiently small to continue (to follow) when the rotation speed of the damper device 10F increases beyond a certain rotation speed. As a result, the range of rotation speed in which the damper device 10F can deliver good vibration damping performance can be expanded.

As in the damper device 10E, so in the damper device 10F shown in FIG. 11, the first spring SP11 as the first transmission member has constant stiffness, while the transmission member Mm2 as the second transmission member has variable stiffness that tends to increase as the rotation speed of the damper device 10F increases. Alternatively, the second transmission member may have constant stiffness, while the first transmission member may have variable stiffness that tends to increase as the rotation speed of the damper device 10F increases. Moreover, both the first and second transmission members may have variable stiffness that tends to increase as the rotation speed of the damper device 10F increases.

In the damper device 10F shown in FIG. 11, the first intermediate member 12 is coupled to the turbine runner 5 of the torque converter TC so as to rotate integrally, but the present disclosure is not limited to this example. Specifically, as indicated by the two-dot dashed lines in FIG. 11, the drive member 11 or the driven member 16 may be coupled to the turbine runner 5 so as to rotate integrally.

As has been described above, a first damper device of the present disclosure is the damper device (10; 10B; 10C) having the input element (11) to which torque from the engine (EG) is transmitted and the output element (16). The damper device (10; 10B; 10C) includes: the first intermediate element (12); the second intermediate element (14); the first transmission member (SP11) that transmits torque between the input element (11) and the first intermediate element (12); the second transmission member (SP12) that transmits torque between the first intermediate element (12) and the output element (16); the third transmission member (SP21) that transmits torque between the input element (11) and the second intermediate element (14); the fourth transmission member (SP22) that transmits torque between the second intermediate element (14) and the output element (16); and the fifth transmission member (Mm) that transmits torque between the first intermediate element (12) and the second intermediate element (14). At least one of the first, second, third, fourth, and fifth transmission members (SP11, SP12, SP21, SP22, Mm) has variable stiffness that tends to increase as the rotation speed of the damper device (10; 10B; 10C) increases.

In the first damper device of the present disclosure, two natural frequencies can be set for the device as a whole. Thus, when resonance occurs at a lower natural frequency of the two natural frequencies as the rotation speed of the damper device increases, one of vibration transmitted from the second transmission member to the output element and vibration transmitted from the fourth transmission member to the output element cancels out at least part of the other, resulting in reduced vibration in the output element. The vibration in the output element is sufficiently reduced when the rotation speed of the damper device reaches a certain rotation speed. Moreover, in this damper device, at least one of the first, second, third, fourth, and fifth transmission members has variable stiffness that tends to increase as the rotation speed of the damper device increases. This allows the state where the vibration in the output element is sufficiently small to continue (to follow) while the rotation speed of the damper device increases beyond a certain rotation speed. As a result, the range of rotation speed in which the damper device can deliver good vibration damping performance can be expanded.

In the first damper device (10; 10B; 10C) of the present disclosure, each of the first, second, third, and fourth transmission members (SP11, SP12, SP21, SP22) may be an elastic body having constant stiffness, while the fifth transmission member (Mm) may have the variable stiffness that tends to increase as the rotation speed of the fifth transmission member (Mm) increases.

In this case, both the first intermediate element (12) and the second intermediate element (14) may have an annular shape, with one located on the inner side to form an inner element and the other located on the outer side to form an outer element, and the fifth transmission member (Mm) may extend in the radial direction when the relative torsional angle between the inner element and the outer element is zero, and may be supported by the inner element so as to be able to pivot and be supported by the outer element so as to be able to pivot and move in the extension direction. Alternatively, both the first intermediate element (12) and the second intermediate element (14) may have an annular shape, with one located on the inner side to form an inner element and the other located on the outer side to form the outer element, and the fifth transmission member (Mm) may extend in the radial direction when the relative torsional angle between the inner element and the outer element is zero, and may be supported by the outer element so as to be able to pivot and be supported by the inner element so as to be able to pivot and move in the extension direction. These structures can cause the stiffness of the intermediate transmission member to increase as the rotation speed of the damper device increases.

In these cases, the fifth transmission member (Mm) may be formed so as to have the center of gravity radially outward of the position at which the fifth transmission member (Mm) is supported so as to be able to pivot. Thus, when the relative torsional angle between the inner element and the outer element changes from zero, a larger force can be exerted by the fifth transmission member onto one of the outer element and the inner element that supports the fifth transmission member so as to be able to pivot and move in the extension direction.

In the first damper device (10; 10B; 10C) of the present disclosure, the damper device (10; 10B; 10C) as a whole has two natural frequencies.

A second damper device of the present disclosure is the damper device (10D) having the input element (11) to which torque from the engine (EG) is transmitted and the output element (16). The damper device (10D) includes: the first torque transmission path having the first intermediate element (12), the first transmission member (SP11) that transmits torque between the input element (11) and the first intermediate element (12), and the second transmission member (Mm2) that transmits torque between the first intermediate element (12) and the output element (16); and the second torque transmission path having the second intermediate element (14), the third transmission member (SP21) that transmits torque between the input element (11) and the second intermediate element (14), and the fourth transmission member (SP22) that transmits torque between the second intermediate element (14) and the output element (16), the second torque transmission path being provided parallel to the first torque transmission path. At least one of the first, second, third, and fourth transmission members (SP11, Mm, SP21, SP22) has variable stiffness that tends to increase as the rotation speed of the damper device (10D) increases.

In the second damper device of the present disclosure, two natural frequencies can be set for the device as a whole, as in the first damper device described above. Thus, when resonance occurs at a lower natural frequency of the two natural frequencies as the rotation speed of the damper device increases, one of vibration transmitted from the second transmission member to the output element and vibration transmitted from the fourth transmission member to the output element cancels out at least part of the other, resulting in reduced vibrations in the output element. The vibration in the output element is sufficiently reduced when the rotation speed of the damper device reaches a certain rotation speed. Moreover, in this damper device, at least one of the first, second, third, and fourth transmission members has variable stiffness that tends to increase as the rotation speed of the damper device increases. This allows the state where the vibration in the output element is sufficiently small to continue (to follow) when the rotation speed of the damper device increases beyond a certain rotation speed. As a result, the range of rotation speed in which the damper device can deliver good vibration damping performance can be expanded.

A third damper device of the present disclosure is the damper device (10E) having the input element (11) to which torque from the engine (EG) is transmitted and the output element (16). The damper device (10E) includes: the first torque transmission path having the intermediate element (12), the first transmission member (SP11) that transmits torque between the input element (11) and the intermediate element (12), and the second transmission member (Mm2) that transmits torque between the intermediate element (12) and the output element (16); and the second torque transmission path having the third transmission member (SP21) that transmits torque between the input element (11) and the output element (16), the second torque transmission path being provided parallel to the first torque transmission path. At least one of the first, second, and third transmission members (SP11, Mm2, SP21) has variable stiffness that tends to increase as the rotation speed of the damper device (10E) increases.

In the third damper device of the present disclosure, when resonance occurs at the natural frequency of the damper device as a whole as the rotation speed of the damper device increases, one of vibration transmitted from the second transmission member to the output element and vibration transmitted from the third transmission member to the output element cancels out at least part of the other, resulting in reduced vibration in the output element. The vibration in the output element is sufficiently reduced when the rotation speed of the damper device reaches a certain rotation speed. Moreover, in this damper device, at least one of the first, second, and third transmission members has variable stiffness that tends to increase as the rotation speed of the damper device increases. This allows the state where the vibration in the output element is sufficiently small to continue (to follow) while the rotation speed of the damper device increases beyond a certain rotation speed. As a result, the range of rotation speed in which the damper device can deliver good vibration damping performance can be expanded.

A fourth damper device of the present disclosure is the damper device (10F) having the input element (11) to which torque from the engine (EG) is transmitted and the output element (16). The damper device (10F) includes: the torque transmission path having the intermediate element (12), the first transmission member (SP11) that transmits torque between the input element (11) and the intermediate element (12), and the second transmission member (Mm2) that transmits torque between the intermediate element (12) and the output element (16); and the rotary inertia mass damper (30) having the mass bodies (32, 32m) that rotate in response to a relative rotation between the input element (11) and the output element (16), the rotary inertia mass damper (30) being provided between the input element (11) and the output element (16) so as to be parallel to the torque transmission path. At least one of the first and second transmission members (SP11, Mm2) has variable stiffness that tends to increase as the rotation speed of the damper device (10F) increases.

In the fourth damper device of the present disclosure, the phase of vibration transmitted from the input element to the output element through the torque transmission path and the phase of vibration transmitted from the input element to the output element through the rotary inertia mass damper are opposite from each other. When resonance occurs at the natural frequency of the torque transmission path (intermediate element) as the rotation speed of the damper device increases, vibration in the output element is reduced, and the vibration in the output element is sufficiently reduced when the rotation speed of the damper device reaches a certain rotation speed. Moreover, in this damper device, at least one of the first and second transmission members has variable stiffness that tends to increase as the rotation speed of the damper device increases. This allows the state where the vibration in the output element is sufficiently small to continue (to follow) when the rotation speed of the damper device increases beyond a certain rotation speed. As a result, the range of rotation speed in which the damper device can deliver good vibration damping performance can be expanded.

While the embodiment of the present disclosure has been described above, it should be understood that the present disclosure is in no way limited to this embodiment and can be implemented in various forms within the scope of the gist of the disclosure.

### INDUSTRIAL APPLICABILITY

The present disclosure can be used in the damper device manufacturing industry and the like.

1. A damper device comprising:
an input to which torque from an engine is transmitted;
an output;
a first intermediate element;
a second intermediate element;
a first transmission member that transmits torque between the input and the first intermediate element;
a second transmission member that transmits torque between the first intermediate element and the output;
a third transmission member that transmits torque between the input and the second intermediate element;
a fourth transmission member that transmits torque between the second intermediate element and the output; and
a fifth transmission member that transmits torque between the first intermediate element and the second intermediate element, wherein
at least one of the first, second, third, fourth, and fifth transmission members has variable stiffness that tends to increase as a rotation speed of the damper device increases.

2. The damper device according to claim 1, wherein:
each of the first, second, third, and fourth transmission members is an elastic body having constant stiffness; and
the fifth transmission member has the variable stiffness that tends to increase as the rotation speed of the damper device increases.

3. The damper device according to claim 2, wherein:
both the first intermediate element and the second intermediate element have an annular shape, with one located on an inner side to form an inner element and the other located on an outer side to form an outer element; and
the fifth transmission member extends in a radial direction when a relative torsional angle between the inner element and the outer element is zero, and is supported by the inner element so as to be able to pivot and is supported by the outer element so as to be able to pivot and move in a direction in which the fifth transmission member extends.

4. The damper device according to claim 2, wherein:
both the first intermediate element and the second intermediate element have an annular shape, with one located on an inner side to form an inner element and the other located on an outer side to form an outer element; and
the fifth transmission member extends in a radial direction when a relative torsional angle between the inner element and the outer element is zero, and is supported by the outer element so as to be able to pivot and is supported by the inner element so as to be able to pivot and move in a direction in which the fifth transmission member extends.

5. The damper device according to claim 3, wherein the fifth transmission member is formed so as to have a center of gravity radially outward of a position at which the fifth transmission member is supported so as to be able to pivot.

6. The damper device according to claim 1, wherein
the damper device as a whole has two natural frequencies.

7. A damper device comprising:
an input to which torque from an engine is transmitted;
an output;
a first torque transmission path having a first intermediate element, a first transmission member that transmits torque between the input and the first intermediate element, and a second transmission member that transmits torque between the first intermediate element and the output; and
a second torque transmission path having a second intermediate element, a third transmission member that transmits torque between the input and the second intermediate element, and a fourth transmission member that transmits torque between the second intermediate element and the output, the second torque transmission path being provided parallel to the first torque transmission path, wherein
at least one of the first, second, third, and fourth transmission members has variable stiffness that tends to increase as a rotation speed of the damper device increases.

8. A damper device comprising:
an input to which torque from an engine is transmitted;
an output;
a first torque transmission path having an intermediate element, a first transmission member that transmits torque between the input and the intermediate element, and a second transmission member that transmits torque between the intermediate element and the output; and
a second torque transmission path having a third transmission member that transmits torque between the input and the output, the second torque transmission path being provided parallel to the first torque transmission path, wherein
at least one of the first, second, and third transmission members has variable stiffness that tends to increase as a rotation speed of the damper device increases.

9. A damper device comprising:
an input to which torque from an engine is transmitted;
an output;
a torque transmission path having an intermediate element, a first transmission member that transmits torque between the input and the intermediate element, and a second transmission member that transmits torque between the intermediate element and the output; and
a rotary inertia mass damper having a mass body that rotates in response to a relative rotation between the input and the output, the rotary inertia mass damper being provided between the input and the output so as to be parallel to the torque transmission path, wherein
at least one of the first and second transmission members has variable stiffness that tends to increase as a rotation speed of the damper device increases.
